(19) United States
(12) Patent Application Publication
(10) Pub. No.: US 2002/0128810 A1
(43) Pub. Date: Sep. 12, 2002

(54) Systems and methods for simulation, analysis and design of automated assembly systems

(75) Inventors: John J. Craig, Paso Robles, CA (US); Rick L. Guptill, San Jose, CA (US)

Correspondence Address: OLIFF & BERRIDGE, PLC, P.O. BOX 19928, ALEXANDRIA, VA, 22320, US

(73) Assignee: ADEPT TECHNOLOGY, INC., City of Industry, CA

(21) Appl. No.: 10/020,277

(22) Filed: Dec. 18, 2001

Related U.S. Application Data
(60) Provisional application No. 60/258,544, filed on Dec. 29, 2000.

(51) Int. Cl. G06F 17/50

(52) U.S. Cl. 703/17

(57) ABSTRACT

A method for simulating, analyzing and/or designing an automated assembly system including a plurality of resources comprises: defining at least one cell from an automated assembly line; associating an action table with each cell; calculating a duration, a success rate and a repair time for each process step using fundamental data of the resources; and associating the duration, the success rate and the repair time with each process step in each action table. The action table of a respective cell specifies all process steps that are executed in the respective cell. A system for simulating, analyzing and/or designing an automated assembly system comprises a discrete event simulator and a three-dimensional kinematic and dynamic simulator coupled with the discrete event simulator. The kinematic and dynamic simulator generates timing data for the automated assembly system that is used by the discrete event simulator. A system for determining a costed-throughput is also provided.

### INCORPORATION BY REFERENCE

This nonprovisional application claims the benefit of U.S. Provisional Application No. 60/258,544, filed December 29, 2000. The disclosure of U.S. Provisional Application No. 60/258,544 is incorporated herein by reference in its entirety.

### BACKGROUND OF THE INVENTION

1. Field of the Invention

This invention relates to systems and methods for simulating, analyzing and designing automated assembly systems including robots for manufacturing.

2. Description of Related Art

Methods and commercial systems are known for analyzing the effect of tolerances in the assembly of parts that have been modeled with computer aided design (CAD). Examples of such commercial systems are VSA from EAI Inc. and Valisys from Technomatix Inc. Typically, part tolerances are input to these systems and a resulting accumulation or “stack-up” of errors is provided. Similarly, tolerances and the “stack-up” of tolerances may be used to determine possible interactions during the assembly of parts. Hence, the results from these systems take into account only the tolerances of the parts themselves.

Methods and commercial systems are known for capturing process times, combined with time-based failure and repair models. These systems are generally described as discrete event simulation. Examples of such commercial systems are Automod by AutoSimulations Inc., ProModel and Witness. These systems compute data based on estimates of overall behavior of a machine or other process entity. For example, in the case of an assembly failure due to tolerance accumulation of parts, these discrete event simulators make computations based on user input of “high level” values, such as mean time between failure (MTBF). Similarly, these discrete event simulators use estimates for process times to make computations. For example, a user inputs an estimate at the pick-and-place transfer time for an automated assembly for use in calculations of time-based data.

Methods and commercial systems are known for computing detailed timing estimates for automated machinery and other equipment and processes found in typical assembly systems. These systems include three-dimensional (3-D) visualization and are generally described as 3-D factory simulation systems. Examples of such commercial systems are RobCad from Technomatix, Inc., IGRIP from Dassault/Deneb, and CimStation from Adept/Silma. These systems may be used to compute accurate times for some machine motions and other factory processes. However, they provide few, if any, methods for predicting failure rates due to tolerances or other error sources. Therefore, these systems are not applicable to the simulation of the overall automated assembly.

Accounting departments of large manufacturing companies have long used methods to make financial decisions about the use, production costs and acquisition costs of automated equipment. Such methods are generally described as financial metrics for automated assembly systems. Known methods employ traditional accounting methods, such as depreciation, to calculate data for the financial justification of automation.

### SUMMARY OF THE INVENTION

The systems and methods according to one aspect of this invention provide simulation, analysis and/or design of an automated assembly system.

The systems and methods according to one aspect of this invention provide calculation of data regarding an automated assembly system based on fundamental data of the resources associated with the automated assembly system.

The systems and methods according to one aspect of this invention provide simulation, analysis and/or design of an automated assembly system that takes into account both product tolerances and process tolerances.

The systems and methods according to one aspect of this invention provide simulation, analysis and/or design of an automated assembly system that takes into account at least one human operator.

The systems and methods according to one aspect of this invention provide simulation, analysis and/or design of an automated assembly system using a discrete event simulator to process fundamental data of the resources associated with the automated assembly system.

The systems and methods according to one aspect of this invention provide simulation, analysis and/or design of an automated assembly system that takes into account financial considerations and/or data.

The systems and methods according to one aspect of this invention provide a costed-throughput of an automated assembly system.

According to various exemplary embodiments, the methods of this invention comprise dividing an automated assembly line into at least one cell; associating an action table with each cell, the action table of a respective cell specifying all process steps that are executed in the respective cell; calculating a duration, a success rate and a repair time for each process step using fundamental data of the plurality of resources; and associating the duration, the success rate and the repair time with each process step in each action table.

In various exemplary embodiments, the calculating step comprises accessing the fundamental data of the plurality of resources from a resource database.

In some embodiments, calculating the duration for each process step uses fundamental data related to machine specifications. In other embodiments, calculating the duration and/or repair time for each process step involves fundamental data related to at least one human operator. Further, in various exemplary embodiments, a discrete event simulator is used to process the duration, the success rate and the repair time in accordance with the action table of each cell.

In various exemplary embodiments, calculating the success rate for each process step uses fundamental data related to both product tolerances and process tolerances. In various embodiments, calculating the success rate for each process step further uses fundamental data related to equipment failure rates. In other embodiments, the methods further comprise accounting for a stack-up of errors related to both product tolerances and process tolerances throughout the automated assembly line from an upstream cell to a downstream cell.

According to various exemplary embodiments, the systems of this invention comprise a discrete event simulator and a three-dimensional kinematic and dynamic simulator coupled with the discrete event simulator. In various embodiments, the kinematic and dynamic simulator generates timing data for the automated assembly system that is used by the discrete event simulator.

According to other various exemplary embodiments, the systems of this invention utilize a failure model based on both product tolerances and process tolerances; a kinematic and dynamic simulator; a discrete event simulator; and a financial model. In various embodiments, the failure model and the kinematic and dynamic simulator provide data to the discrete event simulator, the discrete event simulator simulates operation of the automated assembly system to obtain a throughput and a yield for the automated assembly system, and the financial model determines a cost of the automated assembly system based on the simulated operation and fundamental data of resources included in the automated assembly system.

In various exemplary embodiments, the financial model takes into account flexible automation and includes means for comparing flexible automation with at least one of manual assembly and fixed automation. In various embodiments, the means for comparing uses changes in fundamental data of resources included in the automated assembly system and changes in process steps of the automated assembly system.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention described in detail below, with reference to the attached drawing figures, in which:

FIG. 1 is a schematic representation of an exemplary embodiment of the systems and methods of this invention;

FIG. 2 is a block diagram illustrating various details of the exemplary embodiment according to FIG. 1;

FIG. 3 is an exemplary flowchart illustrating a first exemplary method employed by the Yield Module according to FIG. 2;

FIG. 4 is an exemplary flowchart illustrating a second exemplary method employed by the Yield Module according to FIG. 2;

FIG. 5 is an exemplary flowchart illustrating a first exemplary method employed by the Line Module according to FIG. 2;

FIG. 6 is an exemplary flowchart illustrating a second exemplary method employed by the Line Module according to FIG. 2;

FIG. 7 is an exemplary flowchart illustrating a third exemplary method employed by the Line Module according to FIG. 2;

FIG. 8 is a schematic representation of an exemplary pick and place assembly;

FIG. 9 is an exemplary flowchart illustrating a fourth exemplary method employed by the Line Module according to FIG. 2; and

FIG. 10 is an exemplary flowchart illustrating a fifth exemplary method employed by the Line Module according to FIG. 2.

### DETAILED DESCRIPTION OF EXEMPLARY EMBODIMENTS

I. Overview

This invention provides methods and systems for computing the productivity of a flexible assembly system and employs CAD models for 3D visualization. An automated assembly manufacturing system is called productive if it produces a large number of functional assemblies per unit time while keeping the overall cost to build and operate the assembly system low. For designing assembly systems that are productive, these systems and methods have been developed that integrate techniques to deal with the issues of, for example: timing of elemental operations of automated machines and processes; failure rates of elemental operations due to part and equipment tolerances; effects of conveyance, buffering, system repair times, etc.; 3D visualization of the modeled process; and a novel financial model with capabilities tailored to modem flexible assembly systems.

The central metric of productivity of an assembly system is the number of good units produced per unit time. For example, the number of cellular phones produced by a certain assembly line, stated in terms of the number of “good assemblies per hour”. One might also speak of “system throughput,” the total number of units produced per unit time, and “system yield,” the percentage of units produced which are “good”. The product of system throughput and system yield gives the number of good units produced per unit time. Another important metric of an assembly system is its cost to build and operate.

The previously unsolved problem is to integrate a large number of elemental pieces of data and use them to compute the number of good units produced per unit time. Examples of elemental data fall into three major categories: timing, failure, and cost.

The methods and systems also use the data elements of timing to generate a model which can accurately predict overall system throughput. The time required for an assembly operation by a piece of automated equipment depends on a number of data elements, including but not limited to, for example: acceleration and velocity achievable for each axis of the machine; control system effects such as settling-time at the end of a motion; time required for tooling and actuated peripherals; time required by various assembly processes; conveyance speed; buffering scheme for WIP; availability of shared resources such as, for example, a human operator; and time required to repair jams and equipment breakdowns.

The methods and systems use the data elements corresponding to failure data to generate a model that can accurately predict overall system yield. Examples of data elements that contribute to causing failures in an assembly system include, but are not limited to, for example: repeatability of the motion of robots and other machines; accuracy of the presentation of parts and assemblies by feeders and conveyors; tolerances of the individual parts comprising the assembly; error-reducing strategies such as centering grippers; the effect of chamfers and other methods to increase success; and likelihood of breakdown of various pieces of equipment.

A good assembly system not only produces a lot of functional assemblies per unit time, but also does not cost a great deal to create and operate over time. Assembly systems are generally combinations of human workers, flexible machines such as industrial robots, and hard automation. Each of these resources has certain costs associated with them. For much of the content of a flexible assembly system, the financial community has well-established methods for accounting for the various hard and soft costs, depreciation, and other factors. However, some of the financial impacts of flexible automation, such as reprogramming and re-use, are not captured by traditional accounting methods. Examples of elemental data that contribute to the financial viability of a system include, but are not limited to: cost of equipment; depreciation rate for various types of equipment; cost of system failures; capture of re-useable portion of equipment during change-over; product change-over time; part feeding and packaging costs; labor rates; cost of floor space; and net present value of capital.

Based on these and other data elements, the methods and systems compute several metrics of interest, such as return on investment, payback time, cash flow, book value, packaging costs, utilization costs, labor costs, scrap costs, repair costs, changeover costs, etc. The methods and systems allow comparison of alternate system designs such as, for example, designs including human labor or hard automation can be compared to a proposed flexible automation system.

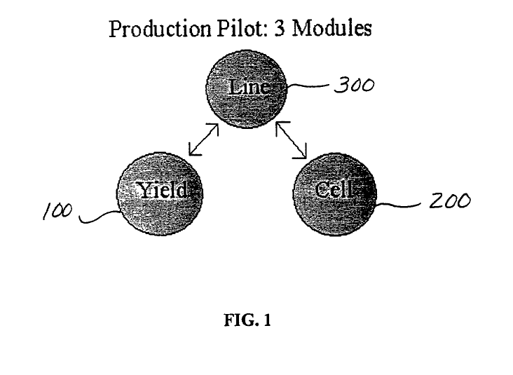

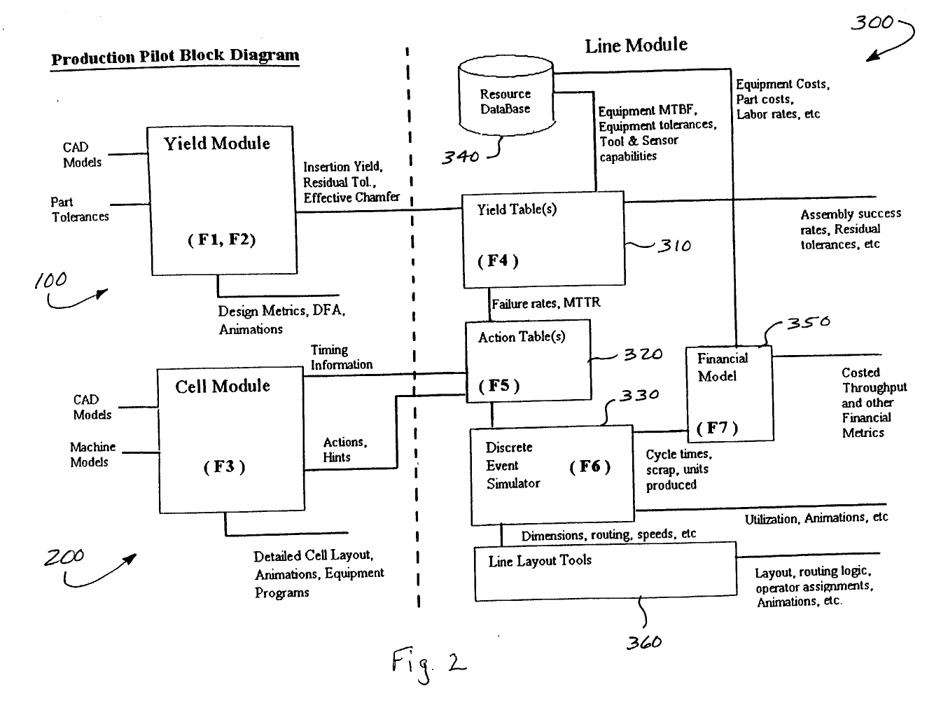

According to an exemplary embodiment of the methods and systems of this invention, as schematically shown in FIG. 1, the overall functionality is divided into three major Modules: a Yield Module 100, a Cell Module 200 and a Line Module 300. As described further below, FIG. 2 is an exemplary block diagram that illustrates various details of the exemplary embodiment represented in FIG. 1. This partitioning of functionality converts the solution into smaller pieces making it more tractable for a user.

The Line Module 300 is a focal point for the overall system and method according to the exemplary embodiment. A top down design would begin and end in the Line Module 300, with the user moving to the Yield Module 100 and the Cell Module 200 as needed to refine methods and data used by the Line Module 300. The Line Module 300 gives the user an overview of the entire assembly line, which is composed of one or more cells and work-in-process (WIP) that moves from cell to cell. In order to keep the rendition of the line uncluttered and considering interactive speed on inexpensive computers, the display of the line in the Line Module 300 is a simplified graphical representation.

The user moves to the Cell Module 200 in order to design or modify the design of an individual cell in the line. In the Cell Module 200, the user interacts with a full, 3-D model of a particular cell, complete with robots or other machines, parts, feeders, fixtures, conveyance systems, and so on. Generally, the Cell Module 200 accomplishes a refinement of the timing information used by the overall line simulator in the Line Module 300.

The user moves to the Yield Module 100 in order to study how the parts themselves go together to form assemblies. This is useful for initial product design, design-for-assembly (DFA) studies, and to assign or view part tolerances and potential yield problems that may occur. Generally, the Yield Module 100 accomplishes a refinement of the parts mating, gripping, or tolerance aspects of the design problem.

As shown in the exemplary block diagram of FIG. 2, the Yield Module 100 may receive inputs such as computer aided design (CAD) models and part tolerances. The Yield Module 100 may provide outputs, such as Insertion Yield, Residual Tolerance and Effective Chamfer, described further below, to the Line Module 300. Also, the Yield Module 100 may provide outputs to the user such as design metrics, design for assembly (DFA) data and animations.

The Cell Module 200 may receive inputs such as computer aided design (CAD) models and machine models. The Cell Module 200 may provide outputs, such as timing information, actions and hints, described further below, to the Line Module 300. Also, the Cell Module 200 may provide outputs to the user such as detailed cell layout, animations and equipment programs.

The Line Module 300 may comprise one or more Yield Tables 310, one or more Action Tables 320, a discrete event simulator 330 and a resource database 340. As shown in FIG. 2, the Line Module 300 may also include a financial model 350 and line layout tools 360 that provide added functionality and capability to the system. The resource database 340 provides fundamental data to the Yield Table 310 and/or the financial model 350 according to the automated assembly system being simulated, analyzed and/or designed. For example, fundamental data may include equipment mean time before failure (MTBF), equipment tolerances, tool capabilities, sensor capabilities and costs such as equipment costs, parts cost, labor rates and the like.

The Yield Table 310 provides data such as failure rates and mean time to repair (MTTR) to the Action Table 320. Yield Table 310 may also provide output to the user such as assembly success rates, residual tolerances and the like. Information in the Action Table 320 is accessed and processed by the discrete event simulator 330 which outputs information such as cycle times, scrap and units produced to the financial model 350, dimensions, routing, speeds and the like to the line layout tools 360 and utilization, animations and the like to the user.

Using fundamental data from the resource database 340 and/or data from the discrete event simulator 330, the financial model 350 calculates and outputs various financial metrics, such as the costed throughput, for the automated assembly system being simulated, analyzed and/or designed. The line layout tools 360 may provide additional information to the user such as layout, routing logic, operator assignments, animations and the like.

II. Yield Module

The Yield Module 100 is used to study how the parts that form the assembly come together. This is useful in initial product design or re-design, a process that is sometimes called design for assembly (DFA). The Yield Module 100 uses 3D CAD models of the parts, and also the grippers or other tools and the fixtures that hold parts or sub-assemblies. In the Yield Module 100, the user concentrates on aspects of the problem, including but not limited to, for example: the order in which the parts are assembled; the direction from which parts are assembled; the need to re- orient parts or the sub-assembly prior to part insertion; which gripper or other tool to use; where to grasp the part; potential collisions between grippers and fixtures during assembly; type of assembly operation, such as snap-fit, gluing, screwing, etc.; tolerances of the individual part features; tolerances associated with the grippers and fixtures; and design for assembly (DFA).

The Yield Module 100 uses CAD models to visualize the order of assembly to be used, and for other data elements. The Yield Module 100 allows the user to import CAD models from a variety of commercial CAD systems. The method and system provide the option of using “dummy” or “place-holder” parts if the CAD models are not available. When the real CAD models are available, they allow for a useful communication tool among the assembly line design team regarding the overall assembly and its parts. The user also interacts with the CAD models in the Yield Module 100 to teach contact features which will come together during the mating operations. The CAD data is used to automatically compute collisions and near misses between parts, tools, and fixtures.

The method and system allow one to study a factory line that is used to build products that are comprised of two or more parts. When two or more parts are joined together, the result is referred to as an assembly. Adding a new part into the assembly is called part insertion or equivalently, part mating. The method and system deal with many of the details of part mating, which can fail in practice. When a part insertion fails, time must be spent fixing or clearing the problem, and the part and/or the assembly may need to be scrapped. These occurrences must be accounted for in the simulator for computations of cost and throughput to be accurate.

In the Yield Module 100, users can define contact features which are physical features on the parts that comprise the assembly to be built. Contact features may be, for example, round or rectangular cross-section pegs and holes. The method and system may also use other geometries for contact features as needed by a particular application. A mate consists of 1 to N pairs of contact features. As described further below, the systems and methods of this invention contemplate an algorithm for computing a Nominal Mate Position from pairs of contact features.

Tolerances can be provided for dimensions of the contact features, such as the diameter of the peg, and for placement of the contact features, such as where the peg is located on the part. If the variation represented by these tolerances is extremely small or zero, the parts would always fit together without any problem. However, since typical tolerances are of moderate size, many problems manifest themselves when trying to assemble parts by automated machinery.

Assumptions are made in various exemplary embodiments of the methods and systems of this invention. For example, parts are assumed to be rigid. The final mating motion is assumed to be a simple linear motion in a single “insertion direction” such that twist insertions or other complicated insertions are not modeled. All mates comprise N pairs of simple peg/hole features such that the mate of a complicated shape, for example, the front and back covers of a cellular telephone, are approximated by a set of pegs and holes. Mating is modeled by Monte-Carlo statistics. The part-mating graph is restricted to a “tree structure”, which means that each new part added to the assembly mates to only one other part in the assembly. Alternative embodiments or implementations need not include this restriction.

Various exemplary embodiments of the methods and systems of this invention provide a graphical user interface (GUI) by which the user can use a computer mouse to graphically pick points on the rendered 3-D model of each part in order to define contact features. The graphical user interface (GUI) also provides a way to override or augment the numerical data derived from the CAD models. This is a practical necessity because some CAD models may be inaccurate or incomplete. Further, the graphical user interface (GUI) provides a means by which the user can specify which pairs of contact features are bought together for a given part mate.

In the Yield Module 100, the descriptions of the mates, contact features, and their tolerances are used to compute an Insertion Yield for each mate. The Insertion Yield is defined for a part as follows. For example, assuming a large number of instances of a particular part, due to the statistical nature of the variations in the contact feature dimensions and locations, some parts will be out of tolerance; that is, it will be impossible to insert them into the assembly without jamming. The percentage of a particular part which can physically fit into the assembly is called the Insertion Yield for that particular part. As described further below, the systems and methods of this invention contemplate an algorithm for computing the Insertion Yield from given tolerances.

Examples of insertion yield for a mate consisting of a simple round peg into a simple round hole are as follows:

A) If the hole diameter is 10 mm+/−0.1 mm and the peg is 11 mm+/−0.1 mm, then the insertion yield is 0.0%.

B) If the hole diameter is 11 mm+/−0.1 mm and the peg is 10 mm+/−0.1 mm, then the insertion yield is 100.0%.

C) If the hole diameter is 10 mm+/−0.0 mm and the peg is 10 mm+/−0.1 mm, then the insertion yield is 50.0% (half of the pegs are too big).

D) If the hole diameter is 10 mm+/−0.0 mm and the peg is 9.9 mm+/−0.2 mm, then the insertion yield is 75%, if the tolerance is uniformly distributed. The insertion yield is 75% because the actual diameters of the pegs will range from 9.7 mm to 10.1 mm with a “uniform” distribution—that is, there are equal numbers of pegs within the 4 ranges: [9.7 to 9.8 mm], [9.8 to 9.9 mm], [9.9 to 10.0 mm], and [10.0 to 10.1 mm] and only those pegs in the last group will fail, resulting in 25% failure.

The methods and systems of this invention will compute the insertion yield for more complicated situations involving combinations of round and rectangular pegs and holes and involving tolerances on individual feature placements. Tolerances can be stated as having uniform distributions or Gaussian distributions.

According to the methods and systems of this invention, Insertion Yield is not dependent on the existence or size of chamfers. In other words, parts are said to fit together if there is some way to put them together, even if it takes many tries to achieve a successful mate. As will be explained hereafter, the Insertion Success, which does depend on the chamfers and various process error sources, is also computed. Note that Insertion Success is generally lower than Insertion Yield.

In the Yield Module 100, the insertion yield for each part used in the assembly is shown to the user. The product of all the insertion yields for each of the individual parts in the assembly gives an overall yield for the assembly.

After a part has been inserted into an assembly, there is generally some remaining relative motion possible between the part and the rest of the assembly. The methods and systems of the Yield Module 100 compute a numeric value for the magnitude of this residual tolerance. As described further below, the systems and methods of this invention contemplate an algorithm for computing the Residual Tolerance in each mate. The Residual Tolerance is important, as it bounds the uncertainty in the position of the just-added part. Since future parts added to the assembly may mate to this part, this uncertainty can be propagated through the stack of parts.

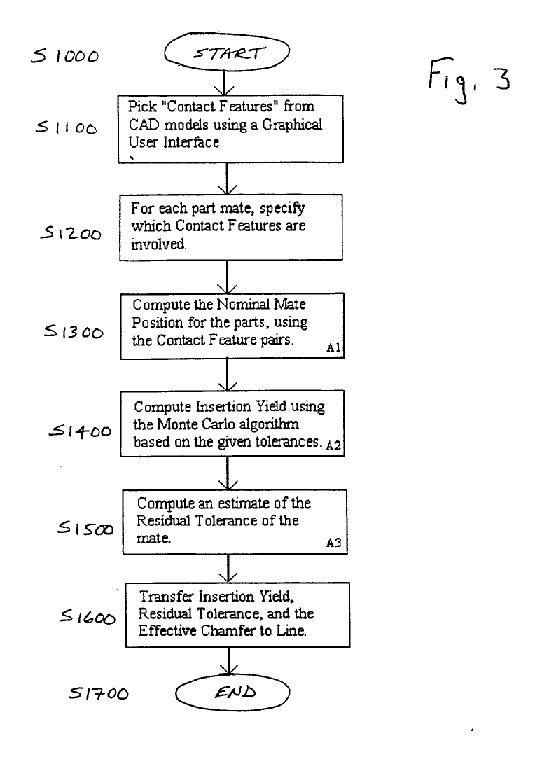

As illustrated in the exemplary flowchart of FIG. 3, the Yield Module 1 00 includes a subroutine for computing the Nominal Mate Position, the Insertion Yield and the Residual Tolerance based on contact feature pairs and tolerances. Control begins in step S1000 and continues to step S1100. In step S1100, the user may access computer aided design (CAD) models via a graphical user interface to select contact features for the proposed assembly or sub-assembly. From the contact features of the proposed assembly or sub-assembly, the involved contact features are then specified for each part mate, as shown in step S1200. Next, in step S1300, the Nominal Mate Position is calculated for the parts of the proposed assembly or sub-assembly. As described further below, the Nominal Mate Position is calculated using contact feature pairs.

Control continues to step S1400 where the Insertion Yield is computed based on given tolerances. As described further below, the Insertion Yield is computed using a Monte Carlo algorithm. Next, in step S1500, an estimate of the Residual Tolerance of each part mate is computed. The Residual Tolerance is computed as described further below.

Once the Insertion Yield and the Residual Tolerance have been calculated, this data and other information, such as the Effective Chamfer, is transferred from the Yield Module 100 to the Line Module 300, as shown in step S1600. Control ends in step S1700.

Note that the Insertion Success in not available in the Yield Module 100, as it depends on more than just the parts and their contact features. Insertion Success depends on the accuracy of the machines moving the parts, whether or not sensors are used to refine positions, and other factors. Insertion Success is computed and displayed in a Yield Table, which is available in the Line Module 300.

The Yield Module 100 may be used to produce animations of the 3D CAD models moving in proper sequence to form an assembly. Such animations are useful as a communication tool. In producing the animations, the Yield Module 100 provides quick generation of default paths for parts to follow as they are introduced into the assembly. The user may refine the default paths as desired, for example, using a graphical user interface. The Yield Module 100 may include an instant reply feature that allows an animation to be moved forward and backward in time, or by prescribed distances. In combination with collision detection tool, positions of nearest approach of one object to another can be identified.

Automatic collision detection may be included in the Yield Module 100 to check that the CAD models of the parts of the assembly do not undesirably collide with each other, or with fixtures or other objects. When used in conjunction with the instant reply feature, the distances between various objects at various times during the assembly process can be logged. The Yield Module 100 may also include a slicing feature that allows a planar slice of one or more CAD shapes to be computed and displayed. A slicing plane can be moved through an assembly to provide sliced contours that can be used to visualize gaps and other details of the fit between parts.

The Yield Module 100 may utilize the DAC Design Tool from Sony Corporation, which includes types of assembly processes, scoring an assembly and other factors. Additional details of this software are described in “Design for Assembly/Disassembly Cost-Effectiveness Manual,” Copyright 1996 by Sony Corporation, which is incorporated by reference herein in its entirety. The Yield Module 100 preferably includes an implementation of, and/or an extension to, the SONY “DAC” system of scoring assemblies of parts. This SONY “DAC” system may be implemented as one of the tools available in the Yield Module 100.

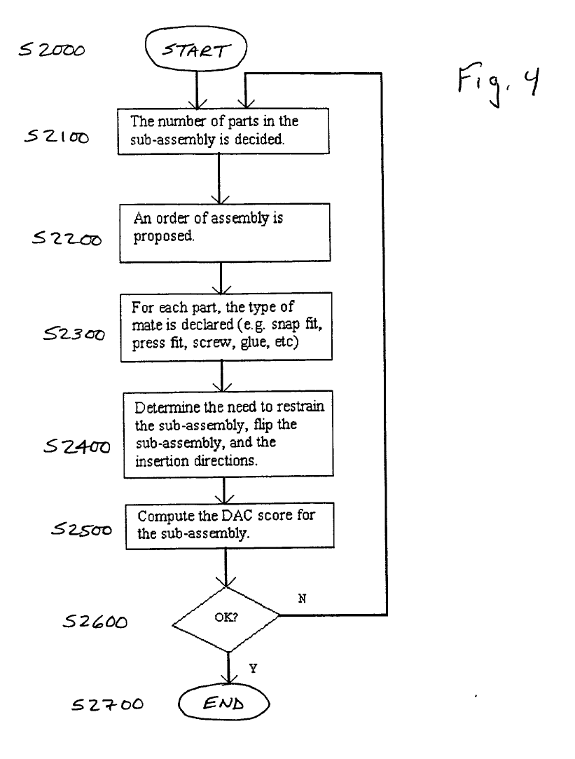

As illustrated in the exemplary flowchart of FIG. 4, the DAC Design Tool used by the Yield Module 100 may include a subroutine that determines whether a proposed assembly or sub-assembly is acceptable based on its DAC score. Control begins in step S2000 and continues to step S2100. In step S2100, a number of parts for the proposed assembly or sub-assembly is determined. Then, in step S2200, a type of mate is specified for each part. For example, the mate may be specified as snap fit, press fit, screw, glue or the like. Next, in step S2300, the required manipulations of the assembly or sub-assembly and the insertion directions are determined. For example, the assembly or sub-assembly may be restrained or flipped.

Control continues to step S2400 where a DAC score is computed for the proposed assembly or sub-assembly based on the above inputs. Details of the DAC score are discussed further below. Next, in step S2500, a determination is made whether the DAC score is acceptable. For example, the user may specify a threshold DAC score for each sub-assembly of a proposed assembly. If the DAC score is not acceptable, control returns to step S2100 for changes in the proposed assembly or sub- assembly. If the DAC score is acceptable, control continues to step S2700 where the subroutine ends.

The fundamentals of assembly operations performed in factories are usually determined by the shape of the designed parts and how they are combined. Considering design for easy assembly from the product design stage (at the very beginning) has played a major role in improving productivity. The effectiveness of design for easy assembly varies depending on when it is applied. For example, if the shape or structure of a part is changed in the stages after product design, the part's mold or the manufacturing equipment may have to be changed at the same time. On the other hand, relatively large changes may be made by considering design for easy assembly in the early stages when fewer restrictions exist.

The DAC Design Tool from Sony Corporation is a system that implements a method that can be referred to as Design for Assembly/Disassembly Cost-Effectiveness. This method is a scheme that can be applied in the very early stages of a project by product designers and/or manufacturing engineers. The DAC Design Tool encourages the designer of the product and/or the automation system to consider the types of assembly processes that will be used to assemble each portion of the product. The graphical user interface of the DAC Design Tool presents the user with choices to indicate the manner of assembly, such as, for example, press fit, gluing, screwing and snap fit. The DAC Design Tool also forces the user to consider the direction from which parts are assembled into the assembly. For example, having all parts coming in from one direction, such as from above, makes the required automation system simpler to design and cheaper to build. The DAC Design Tool also forces the user to consider the need to turn the sub-assembly over and other re-orientations that will be required during the assembly process. Generally speaking, such re-orientations add expense and time to the assembly scheme.

One of the central results of an analysis with the DAC methodology is a score for the assembly of each part in the assembly. A high score, near 100, represents a part that is easy to feed and insert into the assembly. A low score either means that an alternative approach should be considered, or that that particular part is not well suited to automated assembly, and perhaps manual assembly should be considered for that portion of the assembly.

By including the DAC methodology in the Yield Module 100, the methods and systems of this invention may be utilized by product designers and automation engineers even before CAD models exist for the parts. Then, the work can move into the Line Module 300 when the layout of the manufacturing system is begun. Finally, the detailed design of individual work cells can occur in the Cell Module 200. As the design undergoes refinement by the user, the user transfers between the three Modules.

A. Computation of Nominal Mate from Contact Feature Pairs

Consider the case of a part A mating onto a part B. Part A has N pegs or peg-like contact features and part B has a corresponding set of N holes or hole-like features. The user of the system determines a correspondence indicating which pegs go into which holes. The cross-sectional shape of the pegs and holes may be round, rectangular, or other shapes. However, the cross-sectional shapes are always convex. Non-convex shapes can be accommodated by using combinations of convex shapes so that the method is applicable for any contact feature geometry for which a simple linear motion brings part A from an unmated position into a final mated position.

The Nominal Mate Position is the relative position of part A relative to part B when all the corresponding contact features have mated with each other. If we consider, without loss of generality, that part A moves down onto part B along the Z-axis of a reference system, then the algorithm is mostly concerned with finding appropriate values for X, Y, and Theta or rotation about Z. A suitable follow-on minor algorithm is used to determine the Z value. Values for rotation about X and Y are always zero for the mates that are considered.

Starting with a heuristic to guess likely orientations, or values of Theta, about the Z axis, a list of possible Theta values is generated. The algorithm then seeks X and Y translational values which, for the given Theta value, yield a successful mate position. Some examples of the heuristics that may be used include: (1) For each pair of rectangular-peg into rectangular-hole, in the nominal mated position, the peg is assumed to be aligned with the hole in one of four possible orientations, each orientation differing by exactly 90 degrees. From the relative dimensions of the peg and hole, the number of possible orientations can generally be reduced down to 2. For example, a square peg has four possible ways to fit into a square hole, whereas a tight-fitting rectangular peg has only two ways to fit into its corresponding rectangular hole. (2) If there is a case of two round pegs on part A mating into two round holes in part B, a relative orientation for the parts may be guessed in a straightforward manner. For example, a line connecting the centers of the pegs on part A must align in orientation with a line connecting the centers of the holes of part B. Other heuristics may also be applied according to this invention.

A transformation is computed which reduces the size of the holes of part B by a method that takes account of the shape of the corresponding peg on part A as well as the current guess at the relative orientation of part A and part B. For example, the peg may be reduced to a geometric point and the size of the corresponding hole may also be reduced so that the resulting hole allows the same relative translational freedom between part A and part B using this point as the peg. This type of transformation is well known in many computational geometry algorithms.

A mapping is then performed that translates all of the reduced holes. The amount of the translation, in X and Y, is specified by the relative offsets between the pegs, now reduced to points, of part A. The result of this translation is that a collection of planar convex shapes representing the cross-section of the reduced holes are obtained, all lying at known locations in the plane.

The intersection of the planar convex shapes is then computed. It is a known geometrical property that the intersection of any two convex planar shapes is itself a convex planar shape. Hence, no matter how many feature pairs exist in the mating, computation of a single convex planar shape is assured. It is possible that the result is empty, that is, there is no common intersection between the shapes representing the translated, reduced holes. When the result is empty, there is no possible mating position for part A and part B at the currently guessed orientation or Theta value.

In this way, all of the guessed orientations are considered to compute whether or not a suitable translation exists to produce a mate. Due to part symmetries, it is quite possible for the algorithm to find multiple valid mating positions corresponding to different values of orientation (or Theta).

For each orientation for which a non-empty intersection of shapes occurs, the associated translational values for X and Y may be extracted for the mate. These values are chosen so as to specify a point which is in the centroid of resulting convex planar shape. Centroid in this usage is the point interior to a convex planar shape which maximizes the minimum distance from that point to the border of the shape in any direction. By choosing the centroid, the “optimal” mate position is computed in the sense that all pegs are “centered” in the corresponding holes such that the sideways, X and Y, translational motion before a side wall of a peg makes contact with the side wall of a corresponding hole is maximized.

It should be noted that the same algorithm, with only minor changes, is valid for a case where instead of having all peg-like features on one part, and all hole-like features on the other part, a mix of pegs and holes exists on each part. That is, when the parts mate, N1 pegs are moving into holes, while at the same time N2 holes are moving down over pegs.

The final step of the algorithm is to compute the correct Z value for the mated position. From preceding steps, X, Y, and Theta are determined. The computation of Z is a simple matter of computing an appropriate value of Z such that no peg tip goes beyond the bottom of its corresponding hole, and that the shoulders of a peg do not go beyond the shoulders of its corresponding hole.

All mating positions found according to the above algorithm may be shown graphically to the user so that the user can decide which is desired when multiple mating positions exist.

B. Computation of Insertion Yield from Given Tolerances

Consider the case of a part A mating onto a part B. Part A has N pegs or peg-like contact features and part B has a corresponding set of N holes or hole-like features. The user of the system determines a correspondence indicating which pegs go into which holes. For each feature, the user assigns dimensional tolerances (e.g., the diameter of a peg or hole) and positional tolerances (e.g., the location of the feature relative to the part). Each tolerance may be stated as a spatial distribution function. For example, the diameter of a peg may be known to follow a Gaussian distribution, specified by its “one-sigma” value, due to manufacturing variations when the part was made.

The percentage of parts that can be fit into the assembly is computed. In the case of Insertion Yield, this value does not depend on chamfers or manufacturing processes, but is a function of the parts only. For example, Insertion Yield assumes that given two parts to fit together, as much time as necessary may be spent jiggling and coercing them until they go together. Hence, in normal manufacturing situations, Insertion Yield should be a number quite near to 100%. Only in the case of very tight tolerances in combination with wide part variations should the Insertion Yield drop. Insertion Yield, therefore, is the upper limit of the success rate for an actual attempt at insertion with automated machines. A later computation takes into account chamfers and manufacturing process tolerances to compute the overall assembly success rate for each given part.

Starting with the part at its Nominal Mate Position and with nominal values for all dimensional and positional tolerances, the spatial distribution functions associated with each tolerance value are used to choose a set of values randomly from the distributions.

For the instance of parts, it is to be determined if the parts can fit together. That is, whether there exists a relative position and orientation for the part to be inserted such that it will fit into the assembly. The algorithm follows these steps: Try to see if the parts still fit together at the Nominal Mate Position. To check for fit, extract and represent all features as planar shapes (generally convex polygons, though analytic shapes like circles are also handled). The shapes represent the features themselves, not the chamfers, and represent the feature with the current tolerance values applied. Known algorithms of planar geometry are utilized to decide if all pegs are inside their corresponding holes. Such algorithms are a mixture of special case computations for circles and other analytic shapes, and algorithms for general planar polygons. If the part does not fit at the original Nominal Mate Position, a new mate position is computed, not using the nominal values, but using the current perturbed values for the features. The above steps are repeated to see if the part fits at this position and orientation. If the part does not fit, a three dimensional search in X, Y, and Theta (rotation about Z) is begun for a position and orientation in which the part will fit. From the actual known value of current tolerance perturbations, a good upper bound on the size of the search can be established. Any of several known methods for search may be used.

The number of successful fits found in the search is tracked, and new perturbations are chosen for all tolerance values from their corresponding distributions before repeating the algorithm.

After a sufficient number of iterations have been run, the number of trials and the number of successes are used to compute a percentage success rate, called Insertion Yield.

This algorithm is a member of the class of algorithms known as Monte Carlo algorithms. The longer the algorithm is allowed to run, the more precise an answer is computed.

C. Computation of Residual Tolerance in a Mate

Consider the case of a part A mating onto a part B. Part A has N pegs or peg-like contact features and part B has a corresponding set of N holes or hole-like features. The user of the system determines a correspondence indicating which pegs go into which holes.

An estimate of the amount of remaining freedom, in translation and rotation, that remains for a given part after it has been assembled is computed. Or, if the part is glued or somehow rigidly attached, even though there is no longer any relative motion, an estimate of the distribution of positions that the part can take on, assuming a successful mate, is computed.

The value does not depend on feature tolerances. As such, the estimate for Residual Tolerance is valid for all instances of the part. Hence, the value is a function only of the nominal features and has no dependence on the size of chamfers, as they are no longer relevant once parts have been mated.

The value is easily extracted from the results of the algorithm for computing the Nominal Mate Position. In that algorithm, the centroid of a certain planar shape was determined.

For any reference system of interest, one can compute the distance from the centroid to the edge of the planar shape found in the algorithm for computing the Nominal Mate Position. This distance is the amount of relative motion possible between the nominal parts in that certain direction.

In various embodiments, a reference system is used that is associated with user-specified tolerances. In other embodiments, a search may be performed to find a set of axes which optimally represents the Residual Tolerance, or the tolerance could simply be represented as the planar shape found in the algorithm for computing the Nominal Mate Position which gives the complete description of the residual.

III. Cell Module

The Cell Module 200 is used to create a detailed 3-D design and simulation of an individual workcell. This workcell may have one or more assembly robots, other automated machines, and/or human production workers. The Cell Module 200 allows detailed design of the workcell and generates precise timing estimates for the various activities of the cell. The Cell Module 200 also generates 3D visualizations of the processes of the cell for use as a communication tool among the various members of the design and manufacturing team.

Creating a 3D visualization of a particular automated assembly cell relies on importing CAD models from systems which produced them and/or generating 3D CAD representations within the Cell Module 200 itself. The methods and systems of this invention allow both of these approaches. Further, in order for the user to simulate the actions of the workcell, some form of traditional programming is required to describe the tasks to be performed. In addition to this form of traditional programming, the methods and systems of this invention include the use of so-called parametric peripherals which are endowed with certain behaviors which cause them to perform certain tasks within the simulation.

Given accurate CAD models of all the items in an automated workcell, it is possible to use layout tools to design the layout of the automated workcell. This allows the user to plan for use of space within the factory. The workcell layout allows the user to determine the footprint, floor space required, for the set of operations which that cell will accomplish. Cell layout aids the user in determining the required bill of materials to construct the cell, helps to price the capital equipment, and creates a 3D visualization of the cell. Cell layout also allows the verification that assembly robots and other machinery can reach all points necessary to the task and that the various motions of the machine will not cause collisions with the equipment in the cell. The user can study the feasibility of using alternate machines within the cell by checking reachability and collision status for each of several candidate machines.

In order to provide a good communication tool, the methods and systems of this invention allow the user to smoothly move the view-point from which the simulation is watched and to record such animations in an easy-to-use form, a “movie.” Once a “movie” has been created, it may be viewed by others using a small and simple-to-operate viewer program. Such a viewer program could be used over the internet so that people in various locations could view and discuss the proposed simulated design.

The methods and systems of this invention use physics-based simulation to make the simulation more realistic and easier to program. In other words, certain physical laws, such as gravity, friction, and resiliency, for example, are taken into account by the system. For example, in the methods and systems of this invention, if a robot drops a part, the part falls, bounces, and finally comes to rest in a certain orientation. Thus, the user is not required to program or describe these kinds of actions. In simulating a system in which hundreds of parts move on conveyors, or tumble from one portion of a feeding system to another, it would be laborious to require the user to program such motions.

An important aspect of the physics-based simulation of the methods and systems is predicting the stable states for parts. A stable state is an orientation in which a part of given geometry is able to rest on a horizontal plane in a stable manner. The ability to compute these orientations, as well as their relative likelihoods, is important in the simulation of many part-transporting and part-feeding schemes found in automated manufacturing. Gravity is accounted for in the Cell Module 200. Its magnitude and direction are used in the part dropping, bouncing, and stable state algorithms, such as those based on work by Goldberg et al. as disclosed in, for example, Part Pose Statistics: Estimators and Experiments, IEEE Transactions on Robotics and Automation, 15(5), 849-857, October, 1999, which is incorporated herein by reference in its entirety. Gravity also plays a role in the dynamic models which may be employed for robots and other mechanisms which are simulated.

Accurate simulation of the motions, timing, and other attributes of assembly robots and other mechanisms is important to the simulation studies performed in the Cell Module 200. To this end, the methods and systems employ accurate kinematic models of industrial robots. The kinematic models describe the relationships between the angles and/or lengths of the powered joints of the mechanisms and the resulting position in space of end-effectors, such as a gripper or other tools. Encompassed in the kinematic models are the sometimes complex attributes of robot workspace, multiple solutions, singular configurations, and other phenomena.

When a piece of automated machinery moves to accomplish its task, there are many possible trajectories for how it moves from point A to point B. Generally, the manufacturer of the mechanism and/or its control system includes detailed choices in the design of a trajectory generation algorithm for the mechanism. In the methods and systems of this invention, it is important to emulate the trajectory generation algorithm so that the results match the actual device, both spatially and temporally. The methods and systems of this invention incorporate several methods for ensuring accurate emulation.

The methods and systems of this invention allow for the use of dynamic models in the simulation of mechanism motion. A primary use of such models is to predict what forces and/or torques are required at the actuators to produce the desired motion. These forces and torques are compared to known limits to determine whether the desired motion, at the desired speed and acceleration, will be feasible. Further, a heating model can predict if a mechanism's actuators will overheat during repetitive tasks. Such dynamic models allow the methods and systems of this invention to predict the peak performance achievable by a mechanism.

The methods and systems of this invention use parametric peripherals in the Cell Module 200. The parametric peripherals allow the simulation of various pieces of equipment typically found in manufacturing systems. A major benefit of parametric peripherals is simplified use by the user who would otherwise have to model the geometry in a CAD system and program the actions, logic and/or behavior of the mechanism. Parametric peripherals are easily created by filling out a few parameter values that describe the size and behavior of the mechanism. Examples of mechanisms that are modeled as parametric peripherals include, but are not limited to: tools, pallets, cameras, conveyors, sensors, trays and parts. The geometry, or shape, of mechanisms created as parametric peripherals need not be modeled in a CAD system. Rather, a few dimensions are specified in a user-interface panel, and based on those values, the 3D geometry is automatically created.

Many parametric peripherals simulate actual mechanisms which are wired to ports on a local controller, such as the robot's controller or a cell controller. The mechanisms are controlled by setting digital values on the wires that connect to the controller. Parametric peripherals display the same attributes in the simulated world. The parametric peripherals have digital I/O ports which are wired to the simulated controller such that the peripherals perform certain actions or motions when the logical value of their I/O ports are changed. Hence, parametric peripherals not only represent a certain geometry, but also certain logical behavior and, in some cases, motions.

Any 3D simulator will require some method for teaching or specifying the goal positions for robot motions and other positioning. Additionally, the methods and systems of this invention allow for the development of the full program for the robot workcell, which includes logic and communication with other mechanisms in the cell. The programming used in the Cell Module 200 can be employed for any simulated robot and is similar to the language and programming method used with actual robots.

In the methods and systems of this invention, robot goal positions are called locations. The system provides a variety of means for specifying these locations and their associated orientations. In various embodiments, a user may move a virtual robot into a certain position, which is then recorded. In various other embodiments, 3D CAD models are utilized, for example, in which the user can click on the surface of an object and a location will be constructed that lies on and is normal to the object's surface. Locations can be annotated with additional information including, but not limited to, velocity, speed, associated actions, etc.

Provided to the user of the simulator in the Cell Module 200 are several special algorithms that take advantage of the great amount of geometrical and other data in a simulated cell to make useful and time-saving computations to aid the user in more quickly setting up a cell, and creating a design which is optimized in some way.

The Cell Module 200 automatically detects when 3D objects touch or intersect with one another. This ensures that the proposed layout of the cell will function without any collisions between the robots, other machinery, and stationary portions of the workcell. In addition to detecting collisions, the system can also warn of “near miss” conditions.

The Cell Module 200 provides for a function, called autoplace, which computes the locus of possible positions for robot placement such that all locations in the cell operation can be successfully reached. This function can also “score” these locations according to the total time for motions required for any given placement. In this way, the function autoplace can compute the optimal position for placement of the robot relative to parts feeders and work surfaces within the cell.

The Cell Module 200 also provides for a function, called linear Module planner, which computes peak velocities, peak accelerations, minimum cycle time, and checks that heating-limited duty cycle restrictions are met for robots of simple geometry, namely, combinations of linear motion actuators.

IV. Line Module

The Line Module 300 simulates the action of one or more cells which are generally connected together by devices which transport the work-in-process (WIP) between the cells. The Line Module 300 takes a somewhat abstract, simplified view of a collection of cells and the flow of materials between them. With the Line Module 300, problems of material flow, buffering, transport times and overall assembly line layout can be addressed. The Line Module 300 computes many system- wide metrics, such as, for example, a financial model for the assembly line and overall system throughput. A good, top-down design of an assembly line begins and ends in the Line Module 300, with use of the Cell and Yield Modules 100 and 200 for detailing the system design. The Cell and Yield Modules 100 and 200 provide refined timing information and refined failure information, respectively, to the system throughput models in the Line Module 300.

The heart of the Line Module 300 is a discrete event simulator. Discrete event simulators are well known to the industrial simulation community and have been in use in one form or another for 30 years or more. However, traditional discrete event simulators suffer from what may be called the “garbage-in/garbage-out” problem; that is, since the results depend the input information, if the input information is inaccurate, then the results will be inaccurate. The methods and systems of this invention greatly reduce this problem by computing many of the inputs to the discrete event simulator from fundamental, readily available data that is typically more accurate and reliable.

For example, data such as timing information for robot motions within an individual cell is not supplied to the discrete event simulator as estimates. Rather, the timing information is computed from fundamental data that takes into account, for example, the geometry of the robot, trajectory generation details, motor sizes, heating constraints, and various other specific details of the robot.

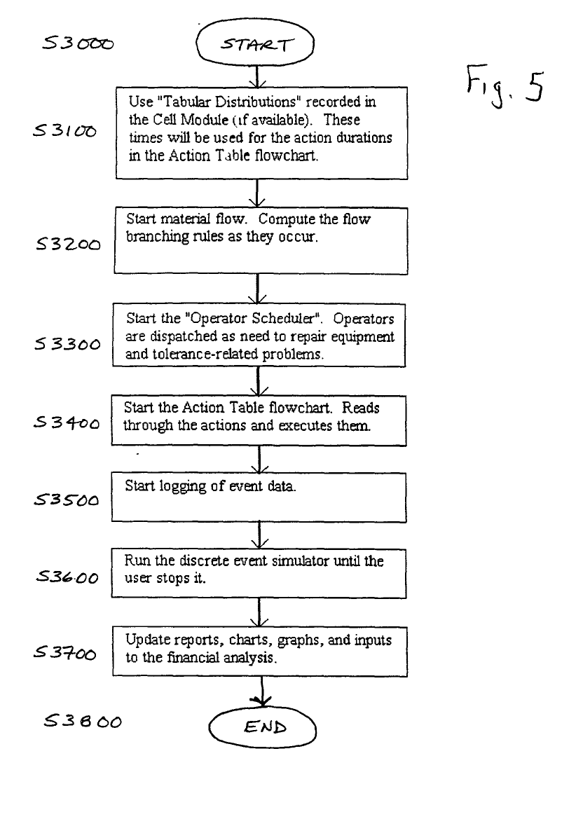

As illustrated in the exemplary flowchart of FIG. 5, the Line Module 300 may include a subroutine that uses fundamental data available in or computed by the system to run the discrete event simulator to obtain data for reports, charts, graphs and/or inputs to the financial analysis. Control begins in step S3000 and continues to step S3100. In step S3100, tabular distributions recorded in the Cell Module 200 may be accessed. Then, in step S3200, the material flow of the assembly process is started and flow branching rules are computed as they occur. Next, in step S3300, the Operator Scheduler is started so that operators will be dispatched as needed. For example, operators may be needed to repair equipment failures and to fix tolerance related problems, such as jammed parts.

Control continues to step S3400 where the actions of the Action Table are accessed and executed. Next, in step S3500, event data of the process is recorded. In step S3600, the discrete event simulator is run. The data produced by the discrete event simulator may be used in step S3700 to update reports, charts, graphs and the like and/or as inputs to a financial analysis. Control continues to step S3800 where the subroutine ends. While steps S3100 to S3600 are shown sequentially in FIG. 5, it should be understood that the steps may run concurrently. Further, the output of data from the discrete event simulator in step S3700 may be continuous, for example, so that the user may interrupt the subroutine when enough data is present to make a decision on the proposed assembly or sub-assembly.

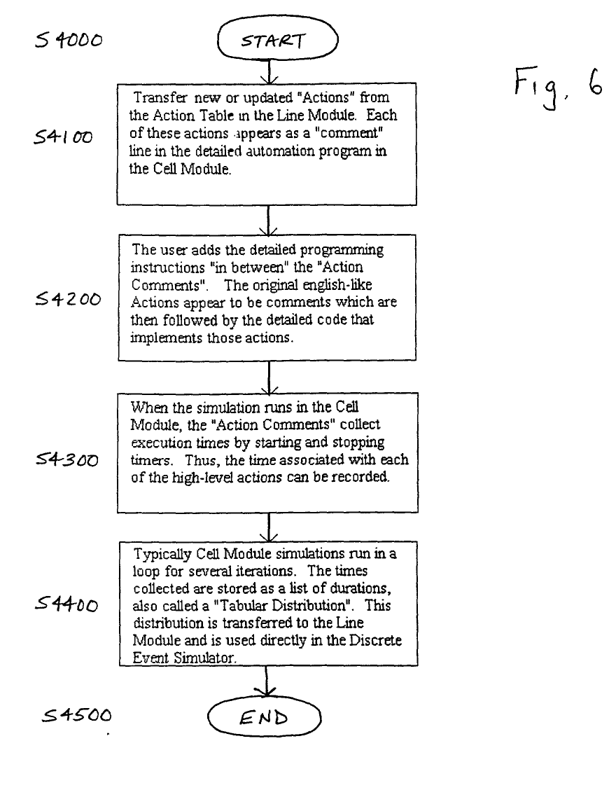

As illustrated in the exemplary flowchart of FIG. 6, the Line Module 300 may include a subroutine for calculating times for the various actions of the assembly process and supplying the times to the discrete event simulator. Control begins in step S4000 and continues to step S4100. In step S4100, the Action Table may be accessed. Then, in step S4200, the user may add detailed programming instructions for the proposed assembly process. For example, when the Action Table comprises a series of comment lines in a detailed automation program in the Cell Module 200, instructions may be added between the existing comment lines. The comment lines may be English-like descriptions of actions that are followed by detailed code that implements the actions.

Next, in step S4300, execution times are collected. For example, timers may be started and stopped as a simulation of the proposed assembly process is run in the Cell Module 200. The time associated with each action can thus be recorded. Control continues to step S4400 where collected times are stored as a list of durations or tabular distributions as the simulation in the run in the Cell Module 200 may be run in a loop for several iterations. As noted above, the tabular distributions may be accessed by the discrete event simulator in the Line Module 300. Control continues to step S4500 where the subroutine ends.

The Line Module 300 also reduces the input data required to more fundamental and readily available data, such as, for example, peak torques and system masses, and then computes the required inputs to the discrete event simulator. Similarly, failure-model inputs used by the discrete event simulator are computed from similarly fundamental data, such as, for example, individual tolerances. In this manner, the methods and systems of this invention provide more realistic and reliable results.

In the Line Module 300, assembly lines are composed of a collection of cells. Items being manufactured called work-in-progress (WIPs) move from one cell to another. Associated with each cell is an action table that specifies which process steps, or “actions” are carried out in that cell. A typical set of process steps begins with a command to wait for a work-in-progress to arrive. Various actions, such as, for example, insertion of parts into the assembly, are then carried out. Generally the final action in the cell is to release the work-in-progress so it can travel or be moved by a human worker to a follow-on cell.

Associated with each action in the action table is a duration, a success rate and a repair time. The duration is the time required for the process step. In various embodiments, the duration is refined using the Cell Module 200. The success rate is the probability that the process step proceeds without failure. In various embodiments, the success rate is refined by using the Yield Module 100. In the case of a failure, an action may include a simulated human operator that is assigned to fix the problem with an associated simulated repair time.

A resource is defined as any capital equipment used in the assembly line and any human production workers or assembly line operators. Basically, everything used to make up the simulated assembly line is a resource, with the exception of the parts and the sub-assemblies composed of previously-assembled parts.

In the methods and systems of this invention, all capital equipment is organized in a resource database according to different categories, for example, conveyors, feeders, robots, tools, etc. The resource database provides a way of storing all kinds of information related to such equipment. Examples of the information stored in the resource database include, but are not limited to: costs, depreciation rates, timing information and tolerance information. For example, a parts feeder would be categorized as bowl, gravity or tape parts feeders, and would be associated with a cost and a presentation tolerance, representing how precisely it present parts. Organizing all the information about the capital equipment in the resource database provides a way for users to build libraries of the equipment they use in their assembly lines. Once entered in the resource database, the information can be re-used easily in future simulations.

In the methods and systems of this invention, human workers are categorized as one of two types of resources, production workers and operators. Production workers are workers that are an integral part of the actions being carried out in a given cell. For example, if a human worker is assembling one or more parts in a cell, that person is categorized as a production worker. Operators are generally responsible for more than one cell. Operators move around the assembly line as needed to carry out actions, such as, for example, replenishing part feeders, repairing failed equipment, and un-jamming parts in feeders or in failed insertions of assemblies.

The Line Module 300 supports multiple designs for the same cell in a given line. This allows comparison between the relative merits of one proposed design over another. Often, such a comparison might be made between a manual cell, featuring a production worker, and a flexible automation cell, featuring a robot. The comparison can be made in terms of overall system costed-throughput. For each different design, the Line Module 300 will compute results in terms of timing, failure rates, scrap, building costs and operating costs.

One part of the discrete event simulator in the Line Module 300 is a failure model which predicts when, and in what ways, the actions being performed in the cells may fail. The simplest way in which an action may fail is failure of a piece of capital equipment. In the resource database, each piece of capital equipment is associated with a statistical distribution that specifies its likelihood of failure. In the Line Module 300, a failure rate is computed for each action taken. Each action may make use of several pieces of equipment for its successful completion. For example, for an “acquire part” action to succeed, failures cannot occur in any of the following pieces of equipment: a feeder, a robot, and a gripper. Thus, the methods and systems of this invention compute an equipment failure rate per operation based on the individual failure rates of all equipment involved in the operation. In this way, the discrete event simulator, which simulates actions, can be supplied with the failure rates on a per-action basis. During the simulation, if a failure occurs, then the piece of equipment that actually failed is determined and reported to the user of the system.

Another way that an action may fail is an accumulation of positioning errors within the various assembled components of the overall assembly. For example, if a part feeder presents a part inaccurately, and if the gripper used to acquire that part does not have a large enough capture zone to accommodate the positioning error, then the acquire part action will fail. Likewise, when a part is inserted into an assembly, if the effective chamfer is not large enough to compensate for positioning errors as the insertion begins, an insertion failure will occur. The failures mentioned in both these examples are called tolerance failures.

In the Action Table of the Line Module 300, a success rate is computed for each action performed in the corresponding cell. For example, the success rate for an action known as “place part” could be called the “insertion” success rate. For a successful pick-and-place operation, the “acquire part” action must also be successful. Therefore, the overall success of the pick-and-place operation would be the product of two success rates, for example, “acquire” and “insertion” success rates, displayed in the action table. In a similar fashion, the overall success rate for the entire process carried out in the cell will be the product of all the individual success rates of the actions in that cell.

The success rate for one action is computed from several different possible failure sources. First of all, each failure in the Line Module 300 is classified as either a “tolerance failure,” for example, a jam occurring at insertion or a mis-pick occurring when picking from a feeder, or an “equipment failure,” for example, the gripper breaking or the conveyor failing. There are always two components to the overall failure percentage: a component due to tolerance failures and a component due to equipment failures. The equipment failure rates come from the Resource Database and the tolerance failure rates are computed from the Yield Table. The user can choose to override the equipment failure rates from the Resource Database by editing values in the action table. In this case, the overridden values are indicated, for example by blue-colored fonts, as being user-overrides. This allows the user to play “what-if” scenarios easily without the need to redefine lots of fundamental information.

The yield table combines many individual values for process tolerances and equipment repair times to compute an overall “success per action” value. Consequently, the yield table mirrors the action table, and for each action from the action table, there appears one or more rows in the yield table. Each of these rows in the yield table is a “component” of the associated action. For example, for the “acquire part” action, an equipment failure could result from the gripper, the robot or the feeder. The yield table displays how all the elemental values of equipment failure rates, as well as tolerance failures, are combined to compute a per-action success rate.

The fundamental paradigm that the yield table supports is the ubiquitous pick-and-place cycle of an assembly system. The simplest pick-and-place cycle is composed of the “acquire part” action followed by the “place part” action. The yield table allows for certain modifications of such basic actions. For example, a “refine grasp” action can be added to represent a sensor that better determines the location of the part within the gripper after the “acquire part” action has occurred. Similarly, a “refine target” action can be inserted into the basic pick-and-place sequence to represent a sensor that better locates the feature(s) into which a part will be mated in an insertion. Finally, an abstract “do” action allows the user to insert any other sort of action needed to simulate the real-world operations of a pick-and-place cycle. The “do” action can be assigned a time duration, a failure rate and a mean time to repair.

Tolerance-related failure in the pick-and-place cycle occurs in two places: when the part is acquired from the feeder and when the part is inserted into the assembly. In both cases, failure is computed using a concept called a capture zone. In the case of grasping a part from a feeder, the capture zone describes the maximum amount by which the gripper and the part can be misaligned while still yielding a successful capture. In the case of inserting a part into an assembly, the capture zone describes the maximum amount by which the part being inserted can be misaligned relative to the mating feature in the assembly and still yield a successful insertion. The effective chamfer affects the capture zone in the case of an insertion.

Underlying data structures are set up to accommodate six-degrees of freedom representation of small errors about a nominal position for objects in the cell. However, the Yield Module 100 may be set up to support a graphical user interface (GUI) and computations in only three-degrees of freedom: X, Y and Theta, rotation about Z. This set up is made for ease of use in representing automated assembly involving four-degree of freedom robots.

The yield table splits each action up into several, typically three to five, elemental tolerance components, each of which represents one source of error. For each of these tolerance components, the user provides data that describes the expected or measured tolerance. The resource database may provide default values for most of these tolerance components by associating individual resources with their spatial-error behavior. For example, a tray conveyor is associated with the spatial- tolerance to which a tray docks at a station. Some robots have error models built-in. Feeders are associated with a presentation tolerance describing how accurately the feeders present parts. The yield table displays all of these tolerance components and allows the user to edit them. As each one is edited, the success rate for the affected action or actions is recomputed.

A statistical Monte Carlo algorithm is used to compute stack up of errors. As the user edits values in the yield table, this algorithm automatically runs to recompute resulting stack-up of errors and success rates. To speed the computation, a modest value of 1000 is used for the number of statistical Monte Carlo iterations. The yield table has a function “refine yields” which can be used to run the Monte Carlo algorithm for more iterations to further refine all computed values. For example, 10000 iterations may be used to refine the computed values.

The yield table is implemented so that a tolerance stack-up graphical user interface can be presented in a one-, two-, or three-degrees of freedom mode. In the three-degree of freedom mode, the user deals with three values of tolerance data, such as X, Y and Theta, and three coordinates to relate successive nominals. Nominals are used since a perturbation in Theta at one point causes a perturbation in X and/or Y on the next stack up of tolerances in a chain of actions. Also, the orientation of X and Y is tracked, because individual tolerance components may be anisotropic or may become so under Theta perturbations at lower points in the stack. Thus, the user views, edits, and understands a total of six numbers for each elemental tolerance component.

In the two-degree of freedom mode, errors about the Z-axis, Theta errors, are assumed to be small and are ignored. With this assumption, the statistical Monte Carlo algorithm is carried out in two degrees of freedom, X and Y. Further with this assumption, the nominals need only be specified with a single number, the rotation about Z between successive reference systems—relative translational offsets between error sources do not matter. Thus, a total of three numbers must be specified for each tolerance component.

In the one-degree of freedom mode, spatial errors in X and Y for each elemental tolerance component are assumed equal, that is, isotropic. Further, errors in Theta are assumed to be small and are ignored. With these assumptions, each elemental tolerance component is specified by one number, the tolerance in X and Y. Thus, nominals are no longer required, as X and Y are isotropic, and no Theta rotational errors occur.

In three-degree of freedom mode, since it is difficult for a user to deal with six numbers, three tolerances and three nominal offsets, per tolerance component, and perhaps also to visualize the individual tolerances, the user is probably required to layout the cell where nominals are relative to one another. Therefore, the following approach is suggested to the user. The one-degree of freedom and two-degree of freedom modes can be used in the Line Module 300 and can be successfully used without having built a detailed cell, or even a cell in the Yield Module 100. However, to take advantage of the greater computation power and accuracy of the three-degree of freedom mode, it is highly recommended that the user first layout the cell in at least the Yield Module 100. It is also prudent to layout the cell laid out with the detailed Cell Module 200.

The assumptions made for the one-degree of freedom mode are somewhat restrictive, and may be unrealistic, but make the system easy to use. The two-degree of freedom mode is a compromise between ease of use and accuracy. The three-degree of freedom mode is considered to be a high-fidelity mode to be used when needed. The one-degree of freedom mode will allow users to learn the concepts underlying the yield table and also provide rough answers quickly, before putting the system into the two-degree of freedom mode or the three-degree of freedom mode to get more accurate results. It may be the case that given the availability of accurate data that the one-degree of freedom mode is the best mode a user will be able to use.

Shown below is an example of a simple action table for a process in which one part is added to a sub-assembly.

| Step | Action | Success % | HTTR | Target Dur. |
|---|---|---|---|---|
| 1. | Acquire Part “PART_1” | 98.4000 | 30.00 | CONST[1.00] |
| 2. | Wait for WIP | 100.0 | 30.00 | CONST[2.00] |
| | “sub_assy_0_1” | | | |
| 3. | Place Part “PART _1” | 99.5000 | 30.00 | CONST[0.50] |
| 4. | Release WIP | 100.0 | 30.00 | CONST[0.10] |
| | “sub_assy_1_2” | | | |
| 5. | | | | |
| ALL | | 97.9080 | 0.6300 | 3.6000 |

Having set up this action table, the corresponding yield table is automatically generated. The corresponding yield table in the one-degree of freedom mode is shown below.

Project

| | | |
|---|---|---|
| Line: my_line | Cell: 1 | Process: proc_1 |

The Yield Table

| # | Action | Component | Equip MTBF | Tolerance | Accumulation | Success | OK |
|---|---|---|---|---|---|---|---|
| 1. | Acquire Part “PART_1” | Feeder | 8000.00 hr | G[250.0] | | | |
| 1.1 | ″ | Mover | 80000.00 hr | G[25.0] | | | |
| 1.2 | ″ | Tool | 500.00 hr | G[25.0] | | | |
| 1.3 | ″ | Grasp | n/a | CAP[C.800.N] | G[250.4] | 99.2994 | N |
| 2. | Wait for VIP “sub_assy_0_1” | Transport | 10.0 hr | G[25.0] | | | |
| 2.1 | ″ | Fixture | 25.00 hr | G[20.0] | | | |
| 2.2 | ″ | Product | n/a | G[20.0] | G[36.6] | 99.9611 | Y |
| 3. | Place Part “PART_1” | Assy Stack | n/a | C[0.0] | | | |
| 3.1 | ″ | Mate Feature | n/a | G[10.0] | | | |
| 3.2 | ″ | Mover | 80000.00 hr | G[25.0] | | | |
| 3.3 | ″ | Tool | 500.00 hr | G[25.0] | | | |
| 3.4 | ″ | Part | n/a | G[5.0] | | | |
| 3.5 | ″ | Mate | n/a | CAP[C.500.R] | G[50.0] | 83.3995 | N |
| 4. | Release VIP “sub_assy_1_2” | Release VIP | 10.0 hr | C[0.0] | C[0.00] | 99.9722 | Y |

Note that on the left hand side, the actions from the action table are presented in sequence order. For each action, there are one or more tolerance components which show the elemental sources of error that contribute to the failure (MTBF) may be associated with each elemental tolerance component. The mean time between failure states how often a piece of capital equipment associated with that action will fail. In the next column, a tolerance is given for each error source. For example, the notation “G[25.0]” indicates that this tolerance is a Gaussian distributed error with a standard deviation of 25.0 microns. Some components have associated capture zones. For example, the “grasp” component in the “acquire part” action has a capture zone specified as “CAP[C,800,N]”. In this notation, “CAP” indicates this component is a capture zone, rather than an elemental error source; the “C,800” indicates that the capture zone is circular with a radius of 800 microns; and, the “N” indicates that after successful capture, residual tolerances are not reduced. Thus, the “N” indicates that the gripper used does not have any centering ability, for example, a simple suction gripper. The “Accumulation” column shows the results of the stack-up of the elemental components for each complete action. For example, in the above example, the total error for how well the “sub_assy_{—}0_{—}1” is presented is “G[36.6]”; that is, the error has a Gaussian distribution with a standard deviation of 36.6 microns. The result of placing the part “PART_{—}1” is a value of “G[50.0]”. In this case, this is the residual stated in the capture zone description, potentially bigger errors being captured by a chamfer and thereby reduced to “G[50.0]”. Finally, a column labeled “Success” shows the overall resulting success rate for each action. The success rate is a combination of failures due to capital equipment mean time between failure and also failures due to tolerance stack-up that causes a capture zone to be missed. The rightmost column compares the computed success rate to a stated goal. In this example, the goal was set to 99.9%. A simple “Y” or “N” is used to indicate whether the yield goal was achieved for that particular action.

The mean time between failure values, as well as the elemental tolerance values, are initially provided from the resource database. These values can be edited in the yield table, which causes the stack-up tolerances to be recomputed. The sizes of capture zones, corresponding to gripper capture zones or product chamfers, may be modified to determine the effect on overall yield. It is possible to specify grasp capture zones which reduce residual tolerance. For example, a parallel-jaw gripper might successfully capture a part and then reduce error through centering action. For such a gripper, the capture zone might be of the form “CAP[C,500,R]”, where the “R” indicates reduction in error after successful capture, or “CAP[C,500,I]”, where the “I” indicates an increase in error due to the grasp capture operation. The amount of increase, like the amount of residual error when “R” is used, is not displayed in the abbreviation shown in the yield table, but can be viewed in a special panel by clicking on that cell of the table.

Note that the accumulation of error for the “acquire part” action totals to “G[250.4]”. This is the residual error specifying that the position of the part is relative to the tool of the robot. From the elemental tolerance components, the biggest error source is the feeder, which has a presentation tolerance of “G[250.0]”. Note also that the success rate for the “place part” action is very low, only 83.3995%, because the error in the part grasp is taken into account in the “place part” action.

One way to improve the above situation would be to use a vision system to refine our knowledge of where the part is relative to the gripping end of the robot after the grasp operation. The updated yield table, when the “refine grasp” action is added to the sequence of operations, is shown below.

The Yield Table

| # | Action | Component | Equip. MTBF | Tolerance | Accumulation | Success | OK |
|---|---|---|---|---|---|---|---|
| 1. | Acquire Part “PART_1” | Feeder | 8000.00 hr | G[250.0] | | | |
| 1.1 | ″ | Mover | 80000.00 hr | G[25.0] | | | |
| 1.2 | ″ | Tool | 500.00 hr | G[25.0] | | | |
| 1.3 | ″ | Grasp | n/a | CAP[C.800.N] | G[243.8] | 99.2994 | N |
| 2. | Refine Grasp “PART_1” | Refine Grasp | 500.000 hr | CAP[A.R] | G[8.0] | 99.9994 | Y |
| 3. | Wait for VIP “sub_assy_0_1” | Transport | 10.0 hr | G[25.0] | | | |
| 3.1 | ″ | Fixture | 25.00 hr | G[20.0] | | | |
| 3.2 | ″ | Product | n/a | G[20.0] | G[38.7] | 99.9611 | Y |
| 4. | Place Part “PART_1” | Assy Stack | n/a | C[0.0] | | | |
| 4.1 | ″ | Mate Feature | n/a | G[10.0] | | | |
| 4.2 | ″ | Mover | 80000.00 hr | G[25.0] | | | |
| 4.3 | ″ | Tool | 500.00 hr | G[25.0] | | | |
| 4.4 | ″ | Part | n/a | G[5.0] | | | |
| 4.5 | ″ | Mate | n/a | CAP[C.500.R] | G[50.0] | 99.9994 | Y |
| 5. | Release VIP “sub_assy_1_2” | Release VIP | 10.0 hr | C[0.0] | C[0.00] | 99.9722 | Y |

The “refine grasp” action specifies “CAP[A,R]” in which the “A” means that the capture portion of the operation always succeeds. This capture zone is also marked “R” as reducing error to a residual of “G[8.0]”, meaning that the vision system refined the position of the part in the grasp to a Gaussian uncertainty with a standard deviation of 8.0 microns. Note that since capture always occurs successfully for the vision system, the associated success rate for this operation, 99.9994%, comes solely from the fact that the vision system has a stated mean time between failure (MTBF) of 500 hours in the above example. Finally, note that the resulting success rate for the “place part” action has increased to 99.9994% because the position of the part in the grasp is known.

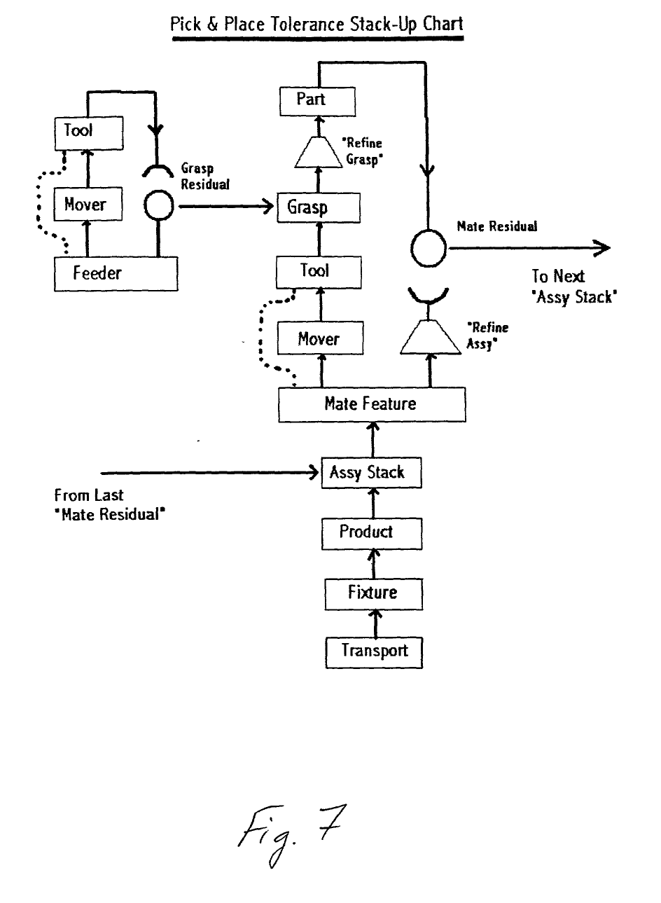

FIG. 7 schematically illustrates the combination of the various elemental tolerances and the capture zone computation made to compute a success rate for the pick-and-place paradigm.

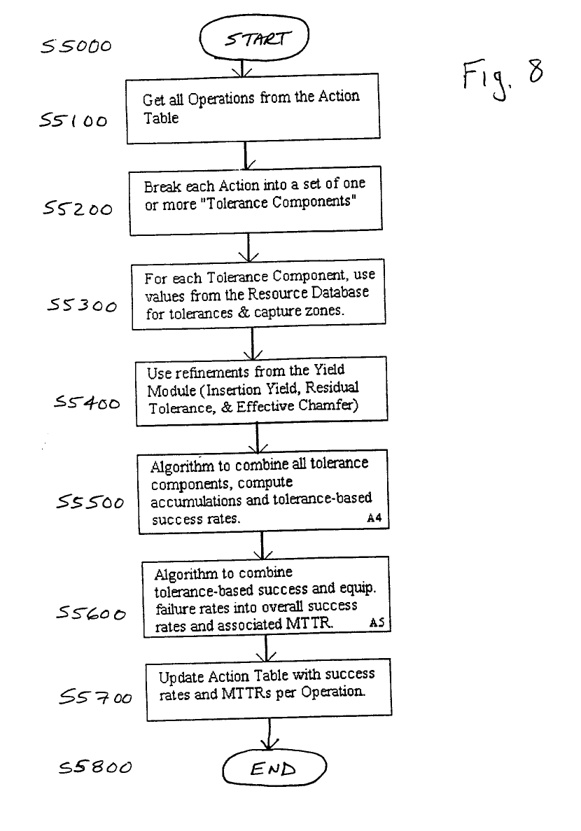

As illustrated in the exemplary flowchart of FIG. 8, the Line Module 300 may include a subroutine for assembling tolerance data and processing the tolerance data to update the Action Table with success rates and mean times to repair (MTTRs) for the various operation of the assembly process. Control begins in step S5000 and continues to step S5100. In step S5100, the Action Table may be accessed for the operations of the proposed assembly process. Then, in step S5200, each operation or action is broken down into one or more tolerance components.

Next, in step S5300, values for the Resource Database are used for tolerances and capture zones for each tolerance component. Control continues to step S5400 where refinements from the Yield Module 100, such as the Insertion Yield, Residual Tolerance and Effective Chamfer, are applied. Then, as further described below, in step S5500, all tolerance components are combined. Also, accumulations of tolerances and tolerance-based success rates are calculated.

Then, in step S5600, as further described below, the tolerance-based success rates and equipment failure rates are combined to obtain overall success rates and associated mean times to repair (MTTRs). Once the overall success rates and associated mean times to repair (MTTRs) are calculated, the Action Table is updated in step S5700. Control continues to step S5800 where the subroutine ends.

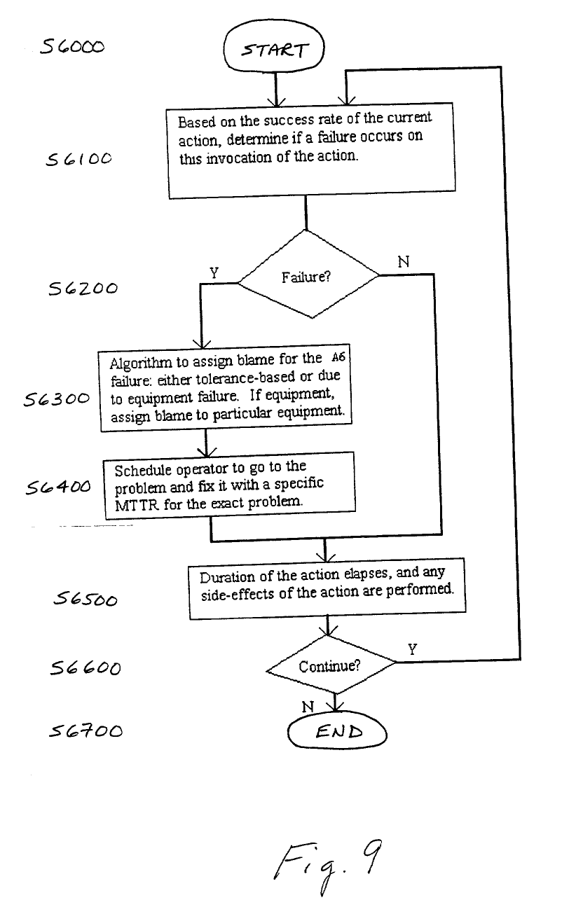

As illustrated in the exemplary flowchart of FIG. 9, the Line Module 300 may include a subroutine for applying the success rates to the proposed assembly process. Control begins in step S6000 and continues to step S6100. In step S6100, the success rate for a given action is accessed from the Action Table. Then, in step S6200, a determination is made whether a failure occurs for the action.

If a failure occurs, a failure model algorithm, described below, assigns blame in step S6300 for the failure, for example, tolerance-based or equipment-based. If the failure is equipment-based, blame is assigned to the particular piece of equipment. Then, in step S6400, an operator is scheduled to fix the failure in accordance with the mean time to repair (MTTR) associated with the particular problem underlying the failure. After the duration of the action elapses, any side-effects of the action are performed in step S6500.

In step S6600, a determination is made whether or not to continue. The subroutine should continue when subsequent actions exist so that control returns to step S6100. When all actions have been executed, then control continues to step S6700 where the subroutine ends.

The Line Module 300 includes a timing model in which each action has an associated duration that states the time required for completion. These durations can be stated as statistical values by giving a mean time and a description of a time distribution function. In a top-down design of an assembly line, these durations can be given by the user in the Line Module 300. By making use of the Cell Module 200, these durations can then be refined and uploaded from the Cell Module 200 into the action table in the Line Module 300. Another important portion of the timing model in the Line Module 300 is the effect of equipment failures and tolerance failures. Each time a failure occurs, an operator must be sent to fix the problem. The methods and systems of this invention employ a scheduler for operators, in case there are multiple pending calls for operators, and a mean time to repair (MTTR) value for any piece of equipment or tolerance jam.

The communication of action durations between the Line Module 300 and the Cell Module 200 is accomplished in a simple way that does not burden the user of the system. The actions from the action table, such as “acquire part and “place part”, will automatically appear as “comments” in the automation program in the Cell Module 200. The user of the Cell Module 200 leaves the “comments” in place, but fills in the actual program statements required to perform the actions. The “comments”, embedded in the program in the Cell Module 200, are used to automatically collect the time that passes between actions. By this technique, the times actually required to execute “acquire part” or “place part” actions, for example, are collected when the detailed 3D simulation runs in the Cell Module 200. When the user returns to the Line Module 300, a pop-up message informs the user that new timing information is now available. Times uploaded in this fashion from the Cell Module 200 occupy a special column in the action table, leaving the original estimated durations in place for comparison.

Whereas the estimated durations would generally be stated in terms of a simple distribution function, the timing values uploaded from the Cell Module 200 are given as tabular distributions. A tabular distribution is a table of the actual times required for each pass through the sequence of actions for that cell. In this way, any effects modeled in the detailed 3D simulation will be exactly captured in the timing distribution used by the discrete event simulator in the Line Module 300.

Failures, whether due to equipment breakdown or tolerances, impact the cycle time and hence the throughput of the assembly line. This impact in cycle time is because, when a failure occurs, a human operator is called to come to the site of the trouble, repair the problem, and then re-start the assembly line. In the methods and systems of this invention, it is possible to specify several operators, and to indicate that certain operators have certain skills as far as which machines they can repair and which part feeders they are assigned to replenish. When a failure occurs, the Line Module 300 uses an operator scheduling function to determine if a qualified operator is currently available to respond to the problem. If so, the operator is dispatched. If not, a first-come, first-served request is entered for that operator. Other styles of operator scheduling may be employed by replacing or augmenting the operator scheduling function.

When an operator is called to effect a repair, the Line Module 300 simulates the time required for the operator to travel from his current location to the source of trouble. In various exemplary embodiments of the methods and systems of this invention, a graphical user interface (GUI) is used so that the user can layout the walkways that operators use to navigate around the assembly line. These walkways, along with a statement of the travel speed of the operator, are used to compute travel times. The operator remains at the source of the problem for a time interval specified by the mean time to repair (MTTR) of the equipment under repair. When the operator is finished with the repair, the actions at the affected cell will re-commence. The operator can either wait at that location, or can begin moving to another scheduled problem, or can return to his waiting station.

A. Success Rates from Tolerance Components

Each elemental source of error, called a Tolerance Component, is quantified, either from the Resource Database 340, or by analysis from the Yield Module 100, or by direct user override (for example, typing in a value). All of these values are displayed in the Yield Table 310. Additionally, associated with each action that can fail due to a tolerance-related problem, there is an associated capture zone which specifies how large of an accumulated error can be tolerated before a failure occurs. The capture zone associated with the Acquire Part action, for example, describes the capture ability of the tool or gripper. The capture zone associated with the Place Part action is also known as the Effective Chamfer and describes the size of the chamfers when a part mating is attempted.

All of these tolerance components are combined and, for each action which may fail due to a tolerance-related problem, the capture zone is applied to compute the percentage of trials which are successfully captured. In this manner, a percentage success rate for the Acquire Part and Place Part actions is computed.

For all the spatial distributions in all the tolerance components, a random set of values is chosen representing the perturbations for a particular trial.

Starting from a ground reference, a series of relative transformations are computed to “stack-up” the perturbations for one chain of transformations that, in the end, yields a overall accumulated perturbation for the location of the part to be picked on the feeder.

Similarly, a chain of perturbations is computed leading to a quantification for the overall accumulated perturbation in the position of the gripper that is about to grasp the part off the feeder.

A check may be applied to see if the above result falls in the capture zone of the tool, given the tool's perturbation as computed above.

Similarly, the overall accumulation of errors is computed leading to a value for the uncertainty in the position and orientation of the sub-assembly into which the part will be inserted.

Similarly, the overall accumulation of errors for the mating feature of the part relative to the mating feature on the base assembly is computed just prior to an attempt at insertion.

A check may be applied to see if the above result yields a successful insertion, given the size of the capture zone, Effective Chamfer, for the particular mate.

Choosing another random set of tolerance errors drawn from the respective spatial distribution functions, the algorithm is repeated, keeping track of the number of successes and total number of trials.

From the total number of trials and successes, a Success Rate is computed as a percentage. As with any Monte Carlo algorithm such as this, the longer the algorithm is allowed to run, the more precision in the computed answer.

B. Combined Tolerance and Equipment Failure Rate and MTTR

For each action in the Action Table 320, there is a chance of failure due to equipment failure, and, for some actions, a chance of failure due to a tolerance-related problem, such as a part mis-pick by a gripper or a jam when insertion is attempted.

For the efficiency of the discrete event simulator, it is advantageous to combine all failure probabilities into one single failure rate. This rate is used, during running of the discrete event simulator, to determine if a failure should occur for a given instance of an action. Once it is determined that a failure occurs, then an algorithm is used to determine which error source to assign blame to. Since failures are relatively rare, a more efficient simulation engine is used by making the failure check for each step as simple as possible, but then spending more computation time when a failure occurs.

First, the failure rate due to tolerance-related problems, if any, is computed from the algorithm for computation of Success Rates from tolerance components.

From the Yield Table 310, using the breakdown of each action into Tolerance Components, the pieces of equipment involved in each action are associated with each Tolerance Component. For example, to successfully complete the Acquire Part action, several pieces of equipment must not fail, such as the robot, the gripper, the feeder, and the like.

For each piece of equipment used for a given action, the Mean Time Between Failure (MTBF) or other statistical measure of the frequency of failure is converted to a per operation success rate.

The success rates from all pieces of involved equipment, as well as from the tolerance analysis, are combined to compute an overall success rate for the action. This computation is the simple multiplication of the success probabilities. For example, given two pieces of equipment that could each succeed with probability 0.9, and the tolerance success rate probability is 0.95, then the overall chance of success is 0.9*0.9*0.95=0.7695 or 76.95%.

A weighted Mean Time To Repair (MTTR) value is displayed in the Action Table 320 which is computed by taking the failure-rate-weighted Mean Times To Repair (MTTRs) associated with each type of problem and it's repair. However, this value is just meant to summarize the expected Mean Time To Repair (MTTR) value. For any actual simulated failure, an algorithm assigns blame, and then the particular Mean Time To Repair (MTTR) associated with that repair is used.

The combined success rate value is all that is used by the discrete event simulator, until there is a failure. At that time, a failure model algorithm is used to assign blame to a particular cause.

C. Failure Model

When a failure occurs for a particular action, blame is first assigned to either a tolerance-related failure or an equipment related failure. This is done by computing the relative likelihood of each type of failure by comparing their individual success rate values. Then, in accordance with the relative likelihood, one cause or the other is randomly selected. Over time, the selection distribution will match the individual likelihoods.

If a tolerance-related problem is blamed, then a Mean Time To Repair (MTTR) associated with an operator fixing the problem is assigned.

If an equipment failure is blamed, then the algorithm continues one more level to assign blame to a particular piece of equipment. This is again done by comparing the relative success rates, on a per-operation basis, for each of the N pieces of equipment involved in the action. Finally, when a determination of which piece of equipment was to blame, then the Mean Time To Repair (MTTR) associated with that repair is assigned.

D. Financial Model

The Line Module 300 also includes a financial model for financial comparison of an assembly line design using flexible automation and an equivalent hard automation or manual assembly line design. Evaluation of different automation types on a cell-by-cell basis is also useful, as many manufacturing lines are a mixture of flexible, fixed, and manual automation. The Line Module 300's financial model allows these kinds of comparisons to be performed.

A first pass at a financial comparison can be accomplished quickly and easily using default values. As better information becomes available, either through running the discrete event simulator, or through finding better values for costs, a more exact financial comparison is possible.

At all times there is a current financial scenario. This contains the current state of the simulated assembly line in the Line Module 300. When it is desired to save the current assembly line's financial status, the graphical user interface allows a name to be assigned to that set of information.

The graphical user interface displaying a “financial justification table” shows a list of all financial scenarios saved with the current assembly line. The graphical user interface can also be configured to show different display panels which report various types of information concerning the current financial scenarios. For example, choosing an “inputs specific to each scenario” panel will show the inputs related to a currently chosen scenario. By choosing different saved scenarios, the information related to that scenario is shown in the “inputs specific to each scenario” display panel.

In various exemplary embodiments, six display panels are provided. A “financial comparison” panel allows comparison of the saved scenarios against a selected “baseline” scenario. An “inputs common to all scenarios” panel provides data that is independent of the particular scenario, such as, for example, hours/year and target production. A “charts” panel provides a graphical display of various financial quantities. An “inputs specific to each scenario” panel displays key inputs driving the financial scenario. An “outputs specific to each scenario” panel displays key outputs of the methods and systems which are used in the financial comparison. A “parts in specific scenario” panel displays values related to the parts which make up the assembly in each scenario.

Once a financial scenario is saved, it will not change unless instructed by the user in one of two ways. The user may directly edit the fields of the scenario. Alternatively, the user may update the scenario from the simulation. If the user would like to play “what if” scenarios with the current values, the graphical user interface allows the user to override various values and to observe the effect of these changes.

In various exemplary embodiments, certain assumptions are made to simplify the method. However, the assumptions may be altered as needed without invalidating the general method. The assumptions may include, but are not limited to, the following:

1. The simulated assembly line will last one year.

2. At the end of the year, the line will be changed over, while trying to keep as much equipment as possible, to build the same type product again. The same type means that the number of parts is the same, but the parts themselves are changed so that certain equipment that is customized to handle the old parts must be replaced.

3. The depreciation for each piece of equipment corresponds to the length of time it will stay in service. Equipment that needs to be replaced should be given a depreciation life of one year.

4. The changeover expense is used in determining how much revenue is lost during the yearly changeover from the old assembly line to the new assembly line.

5. The goal for the annual production desired can be set for the first year only with the same value used for all subsequent years. This number is used to compute the number of identical assembly lines needed to meet the goal.

6. The book value of each scenario is recovered, for example by sale of the assembly line at the end of the production time period.

Numerical values which drive the financial model calculations come from various sources. Many of the values must be specified by the user. Other values associated with resources are stored in the resource database, and need not be re- entered each time. The financial model is interfaced intimately with the discrete event simulator. Thus, a great many numerical values needed by the financial model are computed and supplied by the discrete event simulator. Some key values that drive the financial model and their source include, but are not limited to:

1. Assemblies produced per year. Updated from the discrete event simulator.

2. Startup equipment costs. Updated from the resource database.

3. Annual packaging costs. Updated from the parts table in the Line Module 300.

4. Annual labor costs of production workers and operators. Updated from the resource database.

5. Annual depreciation expenses. Updated from the resource database.

6. Part costs, excluding packaging. Updated from the parts table.

7. Part packaging costs. Updated from the parts table.

8. Annual assemblies scrapped. Updated from the discrete event simulator.

9. Average station equipment error time to repair. Updated from the discrete event simulator.

10. Station average equipment errors per hour. Updated from the discrete event simulator.

11. Annual scrap costs. Updated from the discrete event simulator and the parts table.

In the exemplary “inputs common to all scenarios” display panel, changing an input affects all scenarios saved and is propagated throughout all the other display panels. The values are common to all scenarios and all fields can be edited. None of the values in the “inputs common to all scenarios” display panel come from the simulation. The “inputs common to all scenarios” display panel includes values such as, for example, “desired annual unit volume” that is used to determine a line utilization percentage.

The exemplary “inputs specific to each scenario” display panel includes values for the financial model such as:

Startup Investment Costs: Equipment entered as the sum of the capital equipment on the line; System Design Engineering Hours entered by the user based on the time required to design the line; Freight entered by the user; Installation entered by the user; and, Training entered by the user.

Changeover Expenses: Calendar Days With No Production entered by the user as lost revenue using sale price of assembly times production rate; Calendar Days With 50% Average Production entered by the user as lost revenue using sale price of assembly times production rate; System Design Engineering Hours entered by the user based on the time required to design change over; and, Technician Installation/Debug Hours entered by the user based on the time require to install new assembly line.

Operating Expenses: Special Packaging computed from simulation values; Labor computed from simulation values; Scrap and Repair computed from simulation values; Maintenance entered by the user; Space entered by the user; and, Utilities entered by the user.

Next Year Investment Costs: New Equipment entered by the user; Installation entered by the user; and Depreciation derived from the simulation.

The exemplary “outputs specific to each scenario” display panel includes values for the financial model such as:

Production Volume: Available Hours Per Year set in the “inputs common to all scenarios” display panel; Assemblies Produced Per hour derived from the simulation; Annual Production Capacity: derived from the simulation; Annual Production Needed set in the “inputs common to all scenarios” display panel; Percent Utilization computed in this display panel; Hours Required Per Year computed in this display panel; and Assembly Lines Required To Meet Production Volume computed in this display panel.

Equipment Error Repair Costs: Average Number of Errors Per Hour derived from the simulation; Average Time To Repair Error (Hours) derived from the simulation; and, Annual Cost of Repairing Errors computed from the above in this display panel.

Line Costs: Equipment Hourly Rate (uses Depreciation) $/hr derived from the simulation; Labor Cost (Operators) $/hr derived from the simulation; Labor Cost (Production Workers) $/hr derived from the simulation; Annual Labor Cost derived from the simulation; and, Total Equipment Cost derived from the simulation.

Cell Costs: Equipment Hourly Rate (uses Depreciation) $/hr derived from the simulation; Labor Cost (Operators) $/hr derived from the simulation; Labor Cost (Production Workers) $/hr derived from the simulation; Annual Labor Cost derived from the simulation; and, Total Equipment Cost derived from the simulation.

The exemplary “parts in specific scenarios” display panel includes values for the financial model such as:

Costs For Entire Assembly: Cost Of Assembly (part costs—no packaging) derived from the simulation; Sales Price of Assembly (for changeover cost) adding up the cost of the parts; Annual Assemblies Produced derived from the simulation; Annual Cost of Scrapped Assemblies derived from the simulation; Annual Packaging Cost (from part packaging) derived from the simulation; Annual Assembly Cost (no packaging) derived from the simulation; and, Annual Assembly Cost (including packaging) derived from the simulation.

Costs Per Part: Cost Per Part (excluding packaging) derived from the simulation; Packaging Cost Per Part derived from the simulation; Parts Scrapped Per Year derived from the simulation; Parts Used Per Year (not scrapped) derived from the simulation; Total Parts used Per Year derived from the simulation; Annual Cost of Packaging derived from the simulation; Annual Cost of Scrapped Parts derived from the simulation; and, Annual Total Cost Of Parts derived from the simulation.

The exemplary financial comparison display panel may show a side- by-side comparison of two or more saved financial scenarios.

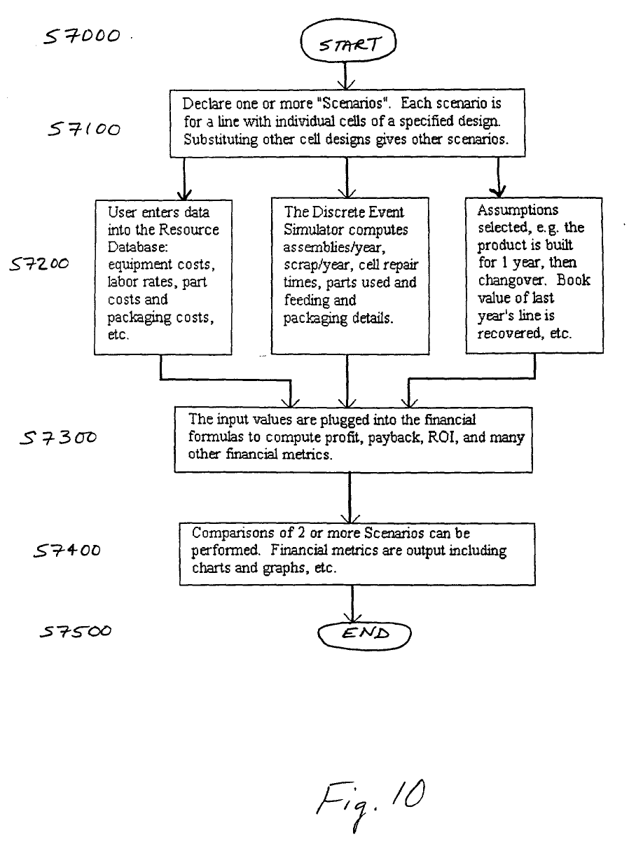

The exemplary flowchart of FIG. 10 illustrates a method for implementing the financial model of the Line Module 300. As shown, the Line Module 300 may include a subroutine for comparing scenarios and/or outputting various financial metrics for proposed assembly processes. Control begins in step S7000 and continues to step S7100. In step S7100, various scenarios for a proposed assembly process are established. For example, each scenario comprises a line with individual cells of a specified design. A change in cell design generates a new scenario.

In step S7200, various data is accessed. For example, the user may enter data into the Resource Database such as equipment costs, parts costs, packaging costs, labor rates and the like. Also, the discrete event simulator may compute data such as the number of assemblies per year, the amount of scrap per year, repair times, parts used, feeding details, packaging details and the like. Further, assumptions may be selected such as the lifetime of the production line before changeover, whether the book value of the previous line is recovered and the like.

In step S7300, the various inputs are used to compute various financial metrics, such as profit, payback, return on investment (ROI) and the like. Then, in step S7400, the financial metrics may be compared for two or more scenarios or may be output as charts, graphs or the like. Control continues to step S7500 where the subroutine ends.

In addition to the financial metrics, there are several types of simulation results provided by the methods and systems of this invention. For example, a variety of bar charts and pie charts may be created to show graphically how each cell in the line operated. Such displays show the percentage of total time spent in each of several states, such as, for example, running, under repair, buffer starved, output blocked and feeder being replenished. Further, individual charts for each feeder and each operator may be used to show the percentage of time spent in various states. Cycle time information may be presented, as well as number of scraped parts and assemblies and number of good assemblies produced per unit time.

Animations of the assembly line running can be produced. Also, the Cell Module 200 can be used to turn the detailed 3D simulations into animations for later review. Similarly, the Yield Module 100 can be used to create animations showing the mating sequence of parts to build the assembly.

The various Modules described herein can be implemented as one or more programmed general purpose computers. It will be appreciated by those skilled in the art that the Modules can be implemented using a single special purpose integrated circuit (e.g., ASIC) having a main or central processor section for overall, system-level control, and separate sections dedicated to performing various different specific computations, functions and other processes under control of the central processor section. The Modules can be a plurality of separate dedicated or programmable integrated or other electronic circuits or devices (e.g., hardwired electronic or logic circuits such as discrete element circuits, or programmable logic devices such as PLDs, PLAs, PALs or the like). The Modules can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the Modules. A distributed processing architecture can be used for maximum data/signal processing capability and speed.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. A method for simulating, analyzing and/or designing an automated assembly system that includes a plurality of resources, comprising:
defining at least one cell from an automated assembly line;
associating an action table with each cell, the action table of a respective cell specifying all process steps that are executed in the respective cell;
calculating a duration, a success rate and a repair time for each process step using fundamental data of the plurality of resources; and
associating the duration, the success rate and the repair time with each process step in each action table.

2. The method of claim 1, wherein the calculating step comprises obtaining the fundamental data of the plurality of resources from a resource database.

3. The method of claim 1, further comprising using a discrete event simulator to process the duration, the success rate and the repair time in accordance with the action table of each cell.

4. The method of claim 1, wherein the fundamental data used in the step of calculating the duration for each process step is related to machine specifications.

5. The method of claim 1, wherein the fundamental data used in the step of calculating the duration for each process step is related to at least one human operator.

6. The method of claim 1, wherein the fundamental data used in the step of calculating the repair time for each process step is related to at least one human operator.

7. The method of claim 1, wherein the fundamental data used in the step of calculating the success rate for each process step is related to both product tolerances and process tolerances.

8. The method of claim 7, further comprising using a discrete event simulator to process the duration, the success rate and the repair time in accordance with the action table of each cell.

9. The method of claim 7, wherein the fundamental data used in the step of calculating the success rate for each process step further is related to equipment failure rates.

10. The method of claim 7, further comprising accounting for a stack-up of errors related to both product tolerances and process tolerances throughout the automated assembly line from an upstream cell to a downstream cell.

11. The method of claim 7, further comprising modifying at least some of the fundamental data of the resources to provide comparison of changes to the automated assembly system.

12. The method of claim 7, further comprising modifying at least one of the process steps to provide comparison of changes to the automated assembly system.

13. The method of claim 1, further comprising calculating an overall throughput of the automated assembly system using the action table.

14. The method of claim 1, further comprising associating at least one operator with the automated assembly system.

15. The method of claim 14, further comprising using a discrete event simulator to process fundamental data related to the at least one operator.

16. The method of claim 15, further comprising dynamically scheduling the at least one operator using fundamental data related to the at least one operator and data from the discrete event simulator.

17. A system for simulating, analyzing and/or designing an automated assembly system, comprising:
a discrete event simulator that simulates operation of the automated assembly system; and
a three-dimensional kinematic and dynamic simulator coupled with the discrete event simulator, the kinematic and dynamic simulator generating timing data for the automated assembly system that is used by the discrete event simulator.

18. A system for determining a costed-throughput of an automated assembly system, comprising:
a failure model based on both product tolerances and process tolerances;
a kinematic and dynamic simulator;
a discrete event simulator; and
a financial model, wherein the failure model and the kinematic and dynamic simulator provide data to the discrete event simulator, the discrete event simulator simulates operation of the automated assembly system to obtain a throughput and a yield for the automated assembly system, and the financial model determines a cost of the automated assembly system based on the simulated operation and fundamental data of resources included in the automated assembly system.

19. The system of claim 18, wherein the financial model takes into account flexible automation and includes means for comparing flexible automation with at least one of manual assembly and fixed automation.

20. The system of claim 19, wherein the means for comparing uses changes in fundamental data of resources included in the automated assembly system and changes in process steps of the automated assembly system.
